(19) United States
(12) Patent Application Publication
(10) Pub. No.: US 2009/0138341 A1
(43) Pub. Date: May 28, 2009

(54) Web Enabled Method for Managing Life Cycle of Human Capital Related Dynamic Requirement of Organization

(76) Inventors: S. Raj Mohan, Bangalore (IN); Sakuntahla Raj Mohan, Bangalore (IN)

Correspondence Address: OLIFF & BERRIDGE, PLC, P.O. BOX 320850, ALEXANDRIA, VA, 22320-4850, US

(21) Appl. No.: 12/227,489

(22) PCT Filed: Apr. 13, 2007
(86) PCT No.: PCT/IN2007/000141

§ 371 Date: Jan. 29, 2009

(30) Foreign Application Priority Data
May 19, 2006 (IN) 00880/CHE/2006

(51) Int. Cl. G06Q 10/00

(52) U.S. Cl. 705/11

(57) ABSTRACT

A web enabled method for managing a life cycle of human capital-related dynamic requirements of an organization by capturing existing goals and/or ethos and/or values of the organization across various business processes and thereby defining required competencies within and across various job families; setting role based performance measures and career growth plans based on defined competencies and captured goals; assessing the human capital on the basis of defined measures and plans to identify skill-gap of the human capital; conducting specific training program to bridge the skill-gap of the human capital and thereby obtaining balance score cards to profile the human capital competency; integrating the assessed competency profile of the human capital in various organizational sourcing channels to enable the organization to search for internal and external sources; and maintaining the balance score cards of the assessed profile for fulfilling human capital service metrics.

### FIELD OF THE INVENTION

The present invention relates to a web enabled method for skill alignment of candidate with dynamic requirements of prospective organization and a method for assessing performance of employees and optionally aligning their skills with the requirements of the organization.

### BACKGROUND OF THE INVENTION AND PRIOR ART

Every growing company has a common problem: finding good people fast enough to meet critical business objectives. Existing options for finding and managing candidates are highly fragmented and time consuming to manage, often including web postings, advertisements, employee referrals, engaging recruiters, and searching resume bulletin boards.

As Internet usage becomes ever more widespread, companies from a broad range of industries are expected to do at least part of their employee recruient over the Internet.

Most companies face another set of challenges having to do with managing the hiring process. While a variety of tools and services for portions of the hiring process exist, there is no single tool which spans the tasks of defining a position, recruiting, interviewing, candidate selection, candidate negotiation, and assimilation of new hires. A central problem with existing approaches is the difficulty communicating what the actual status of the hiring is and what are the next steps of the hiring strategy. “I interviewed him or her, now what do I do?” “I interviewed for 6 hours and I never heard anything from anyone afterwards?” “I opened new job request with the Human Resources Department. It has been over three weeks, and I haven't heard from anyone. What is going on?” Note the problem doesn't change when recruitment is out-sourced, in fact in many circumstances; communications becomes more difficult and/or erratic.

An associated communication problem is the inability for changes in hiring strategies to be communicated to everyone affected. There are many reasons why a hiring position may be either frozen or cancelled, but seldom do the people involved in the hiring activity find out about them in a time-efficient manner. As a consequence, job interviews occur for positions that no longer exist, people are brought long distances for no realistic objective, and they don't find out about it till much later, if ever.

Another problem that pervades this sea of partial solutions is the basic financial management questions, which become so difficult to answer. How much did it actually cost to hire for a given position? How much did the corporate entity lose in delays for hiring that position? How long did it take to fill the position versus when the position was to be filled? Each of these questions is difficult to answer and/or questionable in its accuracy of answer today.

Sitting on top of these problems is a fundamental difficulty in managing a recruient process where there is no established, reliable way to review whether a corporate entity's hiring strategy was accurately implemented, realistically adjusted based upon interim results, and met its corporate objectives.

Today, there is no realistic mechanism supporting the adjustment of a hiring strategy based upon interim results. The options are usually not thought out and reviewed, so management decisions are made in a vacuum. They “just happen” leading to erratic results whose only certainty is they have cost money take time and take resources. The interim results are difficult to coherently collect and review with relevant decision-makers. The consequence of this is more sporadic activity and misdirection, often feeding on itself. Usually costing far more than is reasonable.

There are additional problems with existing personnel tools related to the discontinuity between the various pieces, having to do with the ability to confirm the reality of recruiting management estimates. Many managers will either assume that the job market is the same as it was the last time they hired in a given field, or will choose to paint an unrealistic picture about the effort and expense of filling a given position without even checking. The consequent cost of these managerial mistakes is huge. What is needed is a mechanism providing rapid and accurate feedback to a corporate entity's personnel department or executive group on just what it takes to fill one or more positions.

While all of the discussion so far has focused on the corporate perspective, most of these problems have significant negative consequences for individuals looking for positions. Probably the most annoying problem is the lack of coherent communication. Estimates are that 40% of the people applying for positions on the Internet never get any response to their application.

It is important to understand that most people do not look for another job unless there is a very large reason. They may be unemployed, facing lay-off, or the possibility of lay-off, and/or they may be extremely unhappy or frustrated with their current position. The background of stress, worry, frustration and outright fear can be enormous. So the lack of communication mentioned above has far greater consequences than it would under ordinary circumstances.

Today, an individual is severely limited in their ability to find potential positions relevant to their requirements. They may rely on their circle of friends, family and professional associates, but they face the same problem as the referral service. Most of these people will not or can not understand the job requirements or know the people or companies needing such requirements.

An individual accessing the World Wide Web will find thousands of job web sites and a level of depersonalization that would be daunting to anyone under the best of circumstances, and is often devastating to people, who, for whatever reason, are looking for a job.

### OBJECTS OF THE INVENTION

The primary object of the present invention is directed to methods and systems, implemented in the form of web based applications that can help resolve the foregoing problems and concerns.

Yet another object of the present invention provides web-based systems and methods that facilitate the management of human resources and help drive and contribute to skill alignment of candidate with dynamic requirements of prospective organization and for assessing performance of employees and optionally aligning their skills with the requirements of the organization.

Still another object of the present invention is to provide alignment and lifecycle management solutions for translating the organization's goals, financial, customer-centric and operational into strategic job families, roles and individual job functions.

Still another object of the present invention is to provide supply chain management for facilitating an effective communication between the organization and various HR service provisioning organizational elements with the organizations.

Still another object of the present invention is to provide talent acquisition module to help in managing the end-to-end Talent acquisition process with dynamic priorities.

Still another object of the present invention is to provide Talent Acquisition Planning to help in creating enterprise wide manpower planning down to specific skills demand forecast and their respective sourcing channels.

Still another object of the present invention to provide a Comprehensive knowledge engine which helps organizations defines various competency assessments methods and for identifying his/her knowledge-gap and providing job-role specific program depending on the needs and the performance of the candidate.

Still another object of the present invention is to provide Industry Interaction Model to address the ever increasing Job roles based skills assessment, development, fulfillment, on-going skills assessment and refresh.

Still another object of the present invention provides Client Specific Assessment methods and training program for Job Roles and also client relationship management module.

### STATEMENT OF THE PRESENT INVENTION

The present invention relates to a web enabled method for managing a life cycle of human capital—related dynamic requirements of an organization, said method comprising steps of; capturing existing goals and/or ethos and/or values of the organization across various business processes and thereby defining required competencies within and across various job families; setting role based performance measures and career growth plans based on defined competencies and captured goals; assessing the human capital on the basis of defined measures and plans to identify skill-gap of the human capital; conducting specific training program to bridge the skill-gap of the human capital and thereby obtaining balance score cards to profile the human capital competency; integrating the assessed competency profile of the human capital in various organizational sourcing channels to enable the organization to search for internal and external sources; and maintaining the balance score cards of the assessed profile for fulfilling human capital service metrics and optionally, aligning skills of the assessed human capital with the dynamic requirements of the organization;

a web enabled method for skill alignment of human capital with dynamic requirements of prospective organization, said method comprising steps of; planning for organizational level manpower with HR budgets and thereby identifying appropriate candidates on the basis of predetermined plans; assessing existing skills of the identified human capital using predetermined quality control parameters; identifying skill-gap of assessed human capital with respect to skill requirements of the organization; conducting specific training program to bridge the skill-gap of the human capital; and dynamically updating the score cards of trained human capital for various sourcing metrics to align it with the requirements of the organization and also,

a web enabled system for managing a life cycle of human capital—related dynamic requirements of an organization and for skill alignment of human capital, said system comprises; a server controlled by a work-group computer; said server connects candidate computer system and service provides computer system through communication network; organizational Computer System connected to organization server to access service provider server which is connected to service provider system to provide requirements and to access candidate profiles through said communication network; and means for storing pre-set skill parameters and profiles.

### BRIEF DESCRIPTION OF ACCOMPANYING DRAWINGS

FIG. 1 shows Architecture and components of the invention.

FIG. 2 shows Client Relationship Management-Process flow.

FIG. 3 shows talent Acquisition-Process flow

FIG. 4 shows Jobseeker relationship Management-Process flow

FIG. 5 shows managing the talent acquired-Process flow

FIG. 6 shows Human Resource Management Module—Performance management and Balance score card

FIG. 7 shows Human Resource Management Module—Internal Job posting work flow Management and Internal skill tracking.

FIG. 8 shows alignment and Lifecycle Management Solutions—Organizational Human Capital Alignment.

FIG. 9 shows Alignment and Lifecycle Management Solutions (ALM)—Employee Lifecycle Management.

FIG. 10 shows Talent Acquisition Planning.

FIG. 11 shows Supply Chain Management (SCM) module.

FIG. 12 shows competency Assessment and Development (KMS).

FIGS. 13 -19 shows (Appendices 1-7) a demo of how the process works.

### DETAILED DESCRIPTION OF THE INVENTION

The main embodiment of the present invention is a web enabled method for managing a life cycle of human capital—related dynamic requirements of an organization, said method comprising steps of; capturing existing goals and/or ethos and/or values of the organization across various business processes and thereby defining required competencies within and across various job families; setting role based performance measures and career growth plans based on defined competencies and captured goals; assessing the human capital on the basis of defined measures and plans to identify skill-gap of the human capital; conducting specific training program to bridge the skill-gap of the human capital and thereby obtaining balance score cards to profile the human capital competency; integrating the assessed competency profile of the human capital in various organizational sourcing channels to enable the organization to search for internal and external sources; and maintaining the balance score cards of the assessed profile for fulfilling human capital service metrics and optionally, aligning skills of the assessed human capital with the dynamic requirements of the organization.

In yet another embodiment of the present invention wherein the method provides Strategic Consulting Services selected from a group comprising Strategic Alignment, Organizational Change Management, Organizational (Re)-Design, Performance Benchmarks and Balanced Score Cards roll-out.

In still another embodiment of the present invention wherein assessing the performance using Productivity Tools selected from a group comprising of Bulletin Boards, Focused Communication Group, Pay for Performance Methods, Pro-metric Tests, Self Assessment Tests and Skills Matrix Mapping.

In still another embodiment of the present invention wherein the productivity tools are independent set of applications which are rolled out to bring in operational productivity improvement measures in the organization.

In still another embodiment of the present invention wherein the method comes with a pre-loaded self healing performance tuning mechanisms to enable the organization to align the application performance monitoring, resource usages, and tuning methods for improved performance.

In still another embodiment of the present invention wherein the method is built on open architecture to ensure inter-operability with the organization set-up and for an easy intergratability with the client's human resource Information Systems and human resource Management Systems.

In still another embodiment of the present invention wherein the method provides online portal for effective communication management within and across the various organizational entities.

In still another embodiment of the present invention wherein the method helps in identifying leadership attributes across the and within the organization.

In still another embodiment of the present invention wherein the method manages employee performance in an organization right through their career growth or to the end of the employment life cycle.

In still another embodiment of the present invention wherein the method provides succession planning and developing leadership of employee in the organization.

In still another embodiment of the present invention wherein the method helps in developing and maintaining partnership relations with various organizations.

In still another embodiment of the present invention wherein the method provides platinum premium services comprising Legacy/Existing System Integration Services, Data Migration Services, and Parameterization, Customization Services as per Scope and 24×7 Service Level Agreement Support.

In still another embodiment of the present invention wherein the method provides gold premium services comprising Legacy/Existing System Integration Services, Data Migration Service, and Parameterization, Customization Services as per Scope and 12×6 Service Level Agreement Support.

In still another embodiment of the present invention wherein the method provides silver premium services comprising Legacy/Existing System Integration Services, Data Migration Service, and Parameterization, Customization Services as per Scope and 8×5 Service Level Agreement Support.

In still another embodiment of the present invention wherein the external resource is selected from a group comprising business partner, Job fairs, employee referrals and sourcing partners.

In still another embodiment of the present invention is a web enabled method for skill alignment of human capital with dynamic requirements of prospective organization, said method comprising steps of,

planning for organizational level manpower with HR budgets and thereby identifying appropriate candidates on the basis of predetermined plans; assessing existing skills of the identified human capital using pre-determined quality control parameters; identifying skill-gap of assessed human capital with respect to skill requirements of the organization;

conducting specific training program to bridge the skill-gap of the human capital; and dynamically updating the score cards of trained human capital for various sourcing metrics to align it with the requirements of the organization.

In still another embodiment of the present invention wherein identifying the human capital on the basis of parameters selected from a group comprising Organizational Entity Human Resource Planning, Division Level Human Resource Planning, Skills Demand Forecast, Statistical Models Based Demand Prioritization Methods, Skill Requirements wise calendaring and Event Planner, Quality Parameters Setting for Each Skills Requirement, and Dynamic on-line allocation for Sourcing Channels.

In still another embodiment of the present invention wherein said assessment is either online assessment or consult-led assessment.

In still another embodiment of the present invention wherein the candidates undergo assessments tests selected from a group comprising Group Discussion, Interview and Reading tests for identifying their communication skills and personality standards.

The method as claimed in claim 16, wherein the method provides for On-line Tracking of Sourcing Channels, Dynamic Priority Change Management, Dynamic Allocation, De-Allocation and Re-allocation based on the business priorities, End-to-end Recruitment Life Cycle Monitoring, on-line Status Update for Internal Clients, Candidates Skills Induction Management including the Training Needs definition and Tracking, Employee Skills Competency Mapping, Tracking of HR Budgets and Facilitate the Employment Formalities.

In still another embodiment of the present invention wherein the method provides for relationship management between the organization and the candidate.

In still another embodiment of the present invention wherein the relationship management provides functions selected from a group comprising Existing Resume Migration Capabilities, Ability to Profile Candidate and/or Employees for various Experience and Expertise Summary, Profiling the Candidate and/or Employees for Multiple Job Roles, Searching the suitability of the Candidate and/or Employees for multiple Job Functions, Maintaining the freshness of the profile with on-going relationship through SMS and e-mail Alerts, Personalization of Profiles, Skills Inventory Management for Candidate and Employees, Fuzzy and Intelligent Search and SLA Management with Candidate and Employees.

In still another embodiment of the present invention wherein one or more functions and/or parameters are rolled out independently depending on the level of coverage, existing practice integration and/or alignment, and level of customization required and organizational environment for adoption of work flow driven approach.

In still another embodiment of the present invention a web enabled system for managing a life cycle of human capital—related dynamic requirements of an organization and for skill alignment of human capital, said system comprises; a server controlled by a work-group computer; said server connects candidate computer system and service provides computer system through communication network; organizational Computer System connected to organization server to access service provider server which is connected to service provider system to provide requirements and to access candidate profiles through said communication network; and means for storing pre-set skill parameters and profiles.

In still another embodiment of the present invention wherein means for storing pre-set skill parameters and profiles are service provider database.

In still another embodiment of the present invention wherein the system provides online portal for communication management within and/or across the various organization.

In still another embodiment of the present invention wherein the database is skill bucket and profiles database resident in sever computer system connected to centralized web server through communication link.

With regard to the deployment architecture, ManavSoft is deployed in the centralized server as shown in FIG. 1 so that the end-to-end work flow can be managed through the web interface. The solution will be delivered in a centralized hosting location the servers configurations will start with work-group and/or enterprise class servers with multiple Compute CPU capabilities, the exact size of the server will be configured based on the volume of transactions, number of users, number of skills buckets and other related performance parameters. This exercise will be done prior to the roll-out of ManavSoft in the client location. Trust the above explains the hardware and the connectivity required for the roll-out of ManavSoft.

ManavSoft is a Comprehensive HR Business Management System which combines the Power of Automation with the HR Best Practices and Organizational Alignment Services.

ManavSoft is an Enterprise Application Suite delivered along with HR Process roll-out and Organizational Alignment Services aimed at aligning the HR Services towards the business goals and strategies.

ManavSoft embodies the HR Standard Practices for improved Service Levels and will be delivered through the seasoned HR professionals to customize them as Best Practices and to improve the Overall Operational Efficiency and effectiveness of the Organization.

Manavsoft roll-outs typically are pre-seeded or post-seeded by an organizational alignment services such as Organizational Change Management, Strategic Alignment of HR.

ManavSoft Application Suite covers the end-to-end HR Service Management from Talent Acquisition, Relationship Management and Operational HR Information and Management System.

At the core of ManvSoft is the business driven approach of People, Process and Technology. These are wrapped up by the Application Suite such as Modules which aids the organization to perform end-to-end comprehensive Talent Acquisition Management, Client and JobSeeker/Employee Relationship Management, workflow defined HR Information System and HR Management System.

Manavsoft's Gyan Sristi is a very powerful Knowledge Management System, which can be utilized for Talent Acquisition Process using its Powerful Assessment Engine, as well as for Skills Inventory Management and On-going Skills Refresh Needs.

Gyan Sristi comes pre-configured with over 85 Job Roles and on-going Skills Refresh Modules for Technical and Functional Skills Development needs of an organization.

ManavSoft's Human Resource Management Modules come up with the intergratable components for integration of Client's HRIS and HRMS into the overall schema. These provided the add-on and bolt-on which are mostly custom built and customized for the specific client needs and is always followed suite with a Data Migration Exercise

ManavSoft also provides independent catalogue of HR Productivity Tools such as Policy Creator, Bulletin Board, Special Interest Groups, Pro-metric Tests, Self Assessment tools, Skills Matrix and many other tools that could be crated using the components of Manavsoft as per the client needs.

ManavSoft Services Catalogues have three distinct Deliverables, namely Application Suite roll-out Services, HR Process roll-out Services, and Organizational Alignment Services.

ManavSoft Application Suite Services are delivered through the comprehensive functionalities and Feature Rich Modules being customized to the needs of the Client Organization. Manavsoft comes pre-configured with some custom modules such as e-campus and Survey Solutions.

Manavsoft has other unique feature through its self-healing and correcting mechanisms, whereby the Application Performance Monitoring along with other client Enterprise roll-outs such as ERP, CRM and DB applications, can be reported and corrective actions being taken dynamically.

The HR Process roll-out services will revolve around the areas such as Talent Acquisition, Competency Mapping, SLA Definition and Performance Management and Balanced Score Card.

The Strategic Consulting Services will include services such as Strategic Alignment, Organizational Change Management, Organizational (Re)-Design, Performance Benchmarks and Balanced Score Cards roll-out. Using the ManavSoft Application Suite Modules, we could develop custom specific HR Solutions.

Manavsoft's Application Suites can be rolled out in a modular fashion with any one or many of the modules can be rolled out independently depending on the level of coverage, existing practice integration/alignment, and level of customization required and organizational environment for adoption of such work flow driven approach.

Manavsoft Applications Suites that can be independently rolled out are as follows:
1. Talent Acquisition Module
2. Acquisition Management Module (These two modules are tightly integrated and typically rolled-out in a client organization together)
3. Gyan Sristi, The Knowledge Management Module
4. HR Functions Management
5. Relationship Management (Client, Job Seeker/Employee Management)
Each of these modules is explained in detail as given below:

### Organizational Human Capital Alignment (OHA)

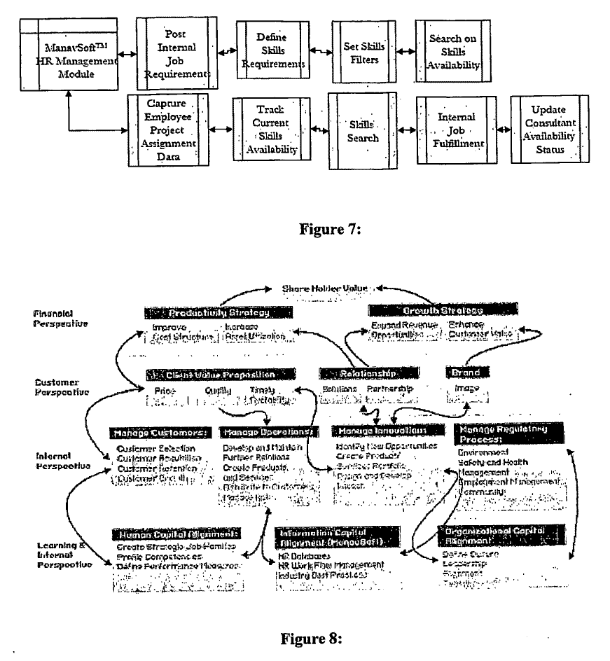

Translates the organization's goals—financial, customer-centric and operational—to strategic job families, roles and individual job functions as shown in FIG. 8 by;
It captures the existing organization's goals/ethos/values across various business processes.
Defines the required competencies within and across various job families
Sets performance measures and career growth plans based on the set goals and objectives.
It helps in identifying leadership attributes across the organization

### Benefits

Translates organization's goals into precise measures
Critical component in the people alignment creating engagements
Contributes to overall organization productivity and employee morale
Clearly identifies career growth plans
Industry best practice templates across various industries

### Employee Life Cycle Management (ELM)

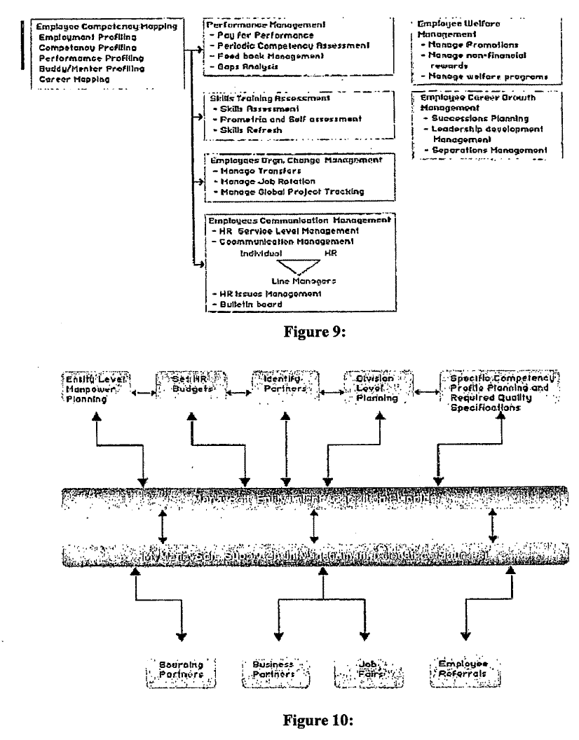

Manages the entire Life Cycle of an Employee from Competency Assessment and Development to Performance Measures to Organizational Alignment; from their induction to separation and beyond, for on-going relationship as shown in FIG. 9.
Employee Competency Profiling
Employee Performance Management right through their career growth or to the end of the employment life cycle.
-Employee Communication Management through an exclusive portal, Manav Assist
Succession Planning and Leadership Development

### Benefits

Significant reduction in People Management Cost
Improved Employee Morale index
Removes ambiguity in the performance
evaluation system
Drastically reduces time-intensive HR administrative activities such as performance management, rewards management (financial/non-financial) and skills development

### ManavSoft—Supply Chain Management (SCM)

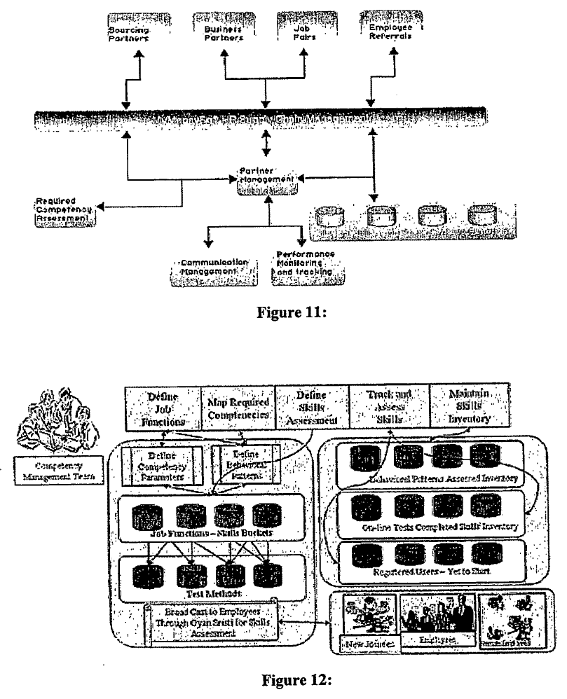

Manavsoft SCM module facilitates an effective communication between the organization and various HR Service Provisioning Organizational elements within the organization and/or external to organization and facilitates HR Services to be delivered as per the Service Level Agreement by the HR Service Providers as shown in FIG. 11.
Enables the organization to execute a formal Service Level Agreements between HR Services Providing entities (Internal as well as External Entities)
Track (m-going Skills Fulfillment across various sourcing channels
Maintain HR Score Cards for various HR Services Fulfillment Metrics

### Benefits

Enables Service Level Agreement (SLA) driven HR Service Delivery Framework
Significantly reduces the communication cost and time within and across various organizational elements and HR Service Providing Organizations
Improves the overall cycle time for various HR services through well defined processes and work flows
On-line tracking and selection across various sourcing channels results in huge HR Costs for Talent Acquisition and Retention.

### Talent Acquisition Management (TAM)

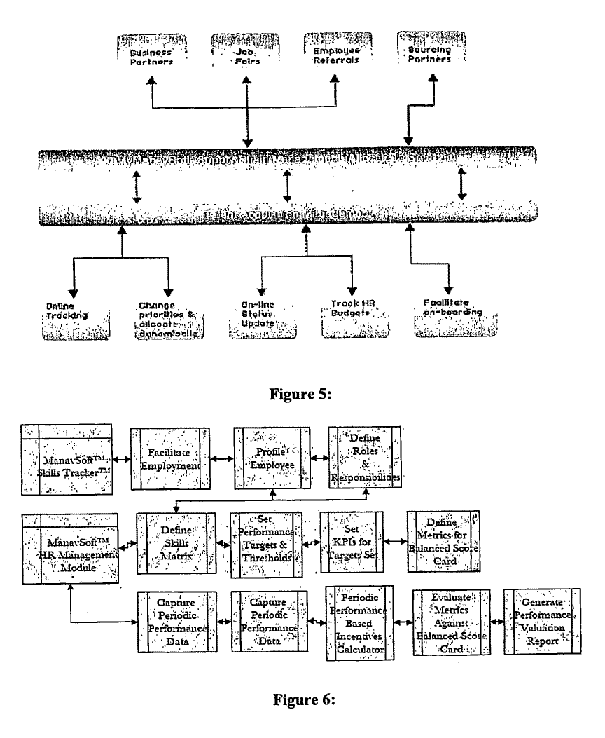

TAM helps in managing the end-to-end Talent Acquisition Process with dynamic priorities, by sourcing the Quality Profiles as per the defined Competencies, QA Parameters through multiple channels against the set budgets as shown in FIG. 5.
Dynamically allocate on-line the Skills Requirements to multiple sourcing channels
First Level screening by set Quality Control (QC) Parameters which reduces significantly the first level basic seek
End-to-end status tracking of the client specific Talent Acquisition Process
HR Score Cards for various sourcing metric

### Benefits

Significant reduction in the initial screening time due to automated Quality Parameters Checking
Significant reduction in the Talent Acquisition Cycle Time
On-line tracking of HR costs and dynamic re-allocations
Improves the overall percentage of “Right person for the Right Job”

### Talent Acquisition Planning (TAP)

TAP helps in creating enterprise wide manpower planning down to specific skills demand forecast and their respective sourcing channels, against set budgets as shown in FIG. 10.
Organizational Level Manpower Planning with HR budgets
Specific skills fulfillment and event planning using scientific Demand Forecasting Models.
Allocation to various sourcing channels

### Benefits

Significant savings in time for Manpower Planning
Clear traction of BR costs and allocations
Aids in reduction of overall talent seek time

### ManavSoft—Client Relationship Management (CRM)

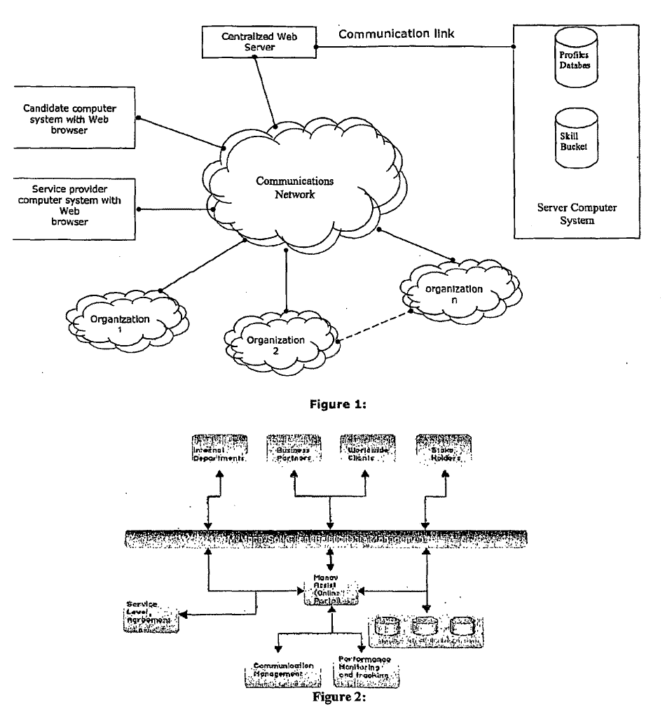

Manavsoft CRM module facilitates an effective communication between and across various organizational elements within the organization and facilitates HR Services to be delivered as per the Service Level Agreement by the HR and People Managers as shown in FIG. 2.
Enables the internal clients to search for internal and external sources of skills inventory
Enter into a formal Service Level Agreements between HR Services Providing entities (Internal as well as External Entities)
Select on-line profiles from across various sourcing channels Track on-going Skills Fulfillment
Communicate within and across various organizational entities through Manav Assist
Maintain HR Score Cards for various HR Services Fulfillment Metrics

### Benefits

Enables Service Level Agreement (SLA) driven HR Service Delivery Framework
Significantly reduces the communication cost and time within and across various organizational elements
Improves the overall cycle time for various HR services through well defined processes and work flows
On-line repository of skills inventory aids in identification of Existing Skills within the organization rather than hiring more of the same new skills through Talent Acquisition.
This results in huge HR Costs for Talent Acquisition and Retention

### Gyan Sristi: Competency Assessment & Development (KMS)

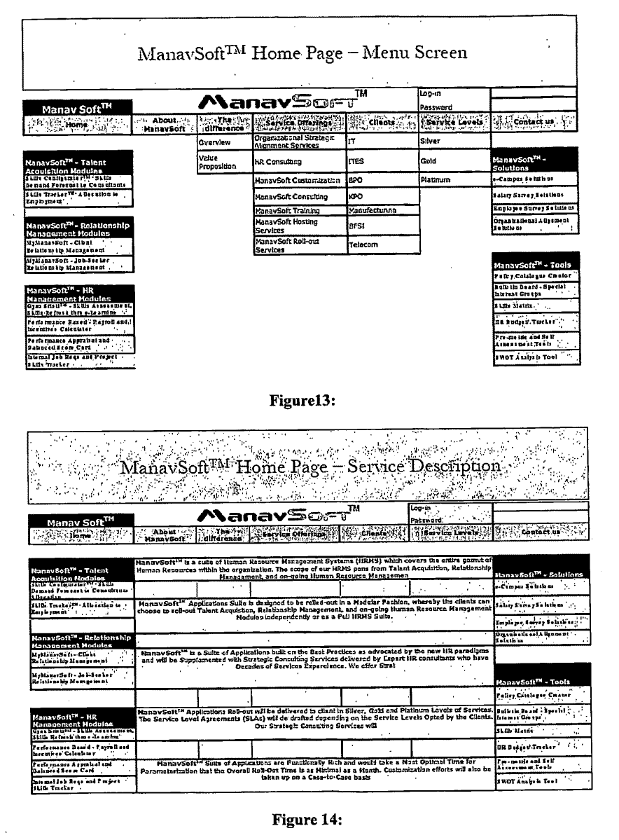

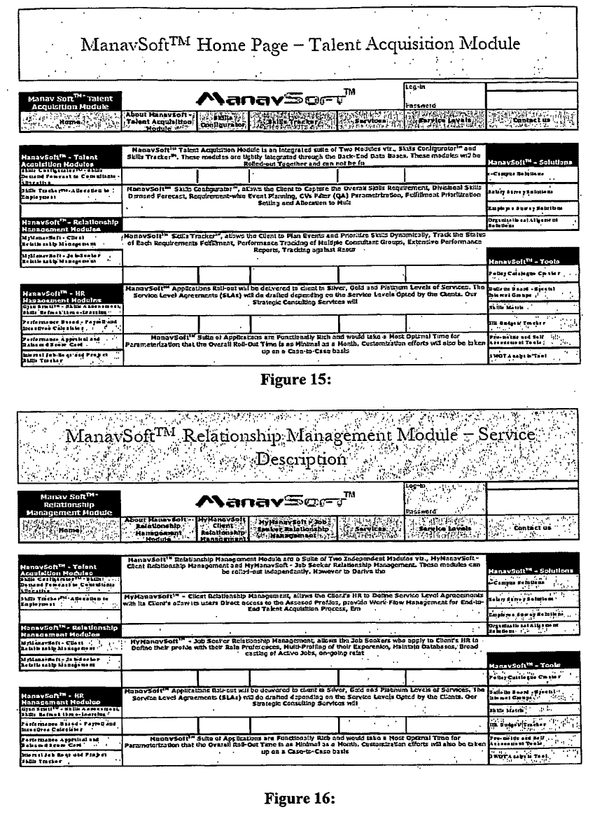

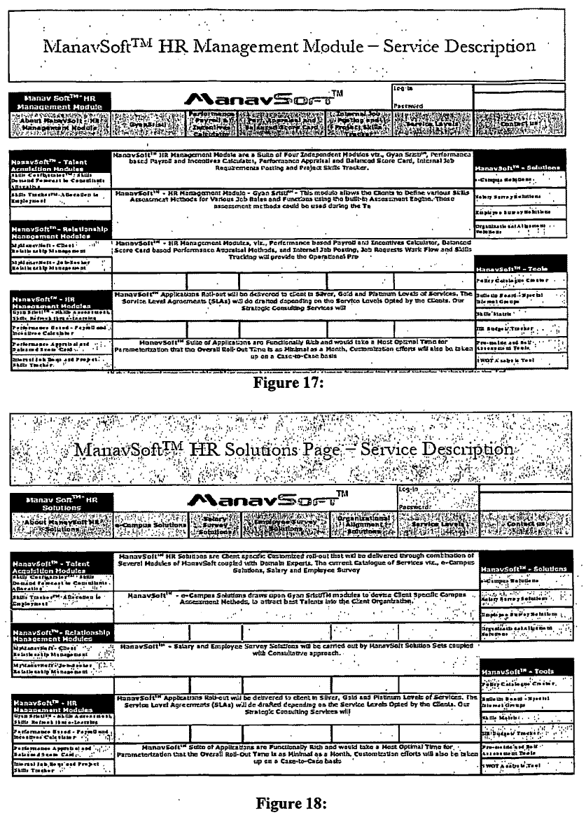

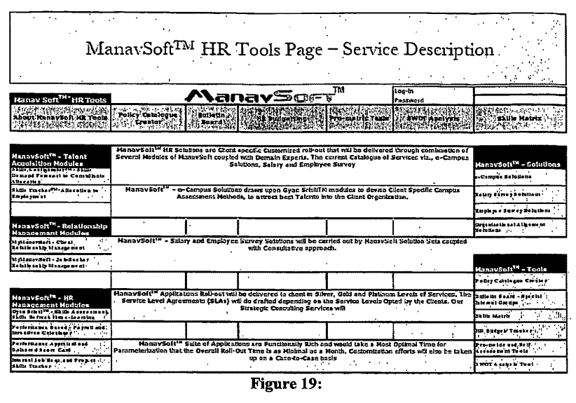

A comprehensive knowledge engine which helps organizations define various competency assessment methods (on-line and/or people managed), identifies competency gaps scientifically and objectively based on which it creates Competency Development maps as shown in FIG. 12.
Competency based assessment
On-line tests and people-led assessment criterion.
Gyan Sristi is used for talent acquisition as well as on-going competency assessments during the Employee's Life Cycle
Creates Competency Development Plans for each employee that aids in Career Growth

### Benefits

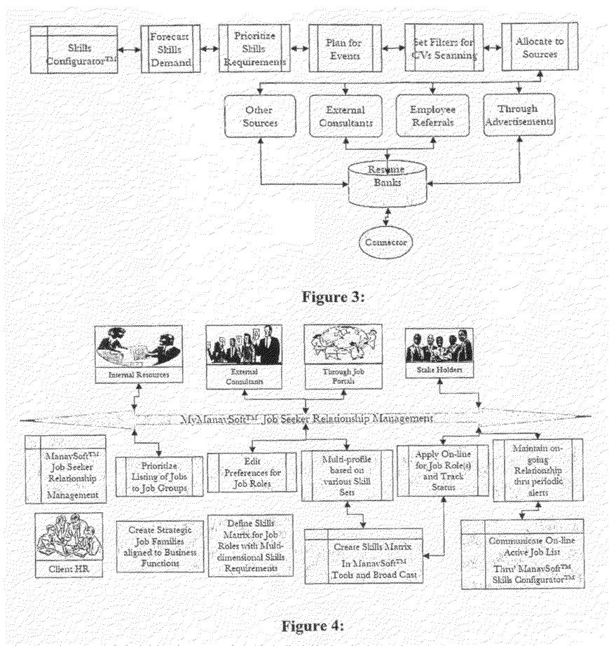

Reduces talent acquisition cycle time significantly specially for large sourcing requirements
Reduces the Administrative burden of Competency Management of employees.
It enables having the employee's competency assessment on an on-going basis.
Reduces People Management time and costs in identifying and developing competencies.
   1. Talent Acquisition Module, flow of process shown in FIG. 3

This module has the following sub-modules:
Organizational Entity Human Resource Planning
Division Level Human Resource Planning
Skills Demand Forecast
Statistical Models Based Demand Prioritization Methods
Skill Requirements wise calendaring and Event Planner
Quality Parameters Setting for Each Skills Requirement
Dynamic on-line allocation for Sourcing Channels
   2. Talent Acquisition Management module as shown in FIG. 5 has the following sub-modules
On-line Tracking of Sourcing Channels
Dynamic Priority Change Management
Dynamic Allocation, De-Allocation and Re-allocation based on the business priorities
End-to-end Recruient Life Cycle Monitoring on-line Status Update for Internal Clients, Job Seekers
Skills Induction Management including the Training Needs definition and Tracking
Employee Skills Competency Mapping
Tracking of HR Budgets
Facilitate the Employment Formalities.

### ManavSoft Gyan Sristi—Knowledge Management

Gyan Sristi has three sub-modules which supports the three Human Resourcing Needs of the Client Organization viz.,
1. Skills Assessment Based Talent Acquisition
2. On-going Skills Inventory and Competency Management
3. Skills Gaps Analysis and On-going Skills Refresh module
   1. Skills Assessment based Talent Acquisition

Job Roles Definition for Specific Skills (Gyan Sristi comes pre-configured with 85 Job Roles)
Definition of Skills Assessment needs for each of the Job Roles
Definition for the Manual Assessment Criteria for each of the Job Roles
Weightage setting for the Selection Criteria
Performance of Skills Assessment on-line
Facility to Schedule on-line for Face to Face Meetings and Soft Skills Assessment
Ability for Job Seeker being assessed on various Job Roles based on the selection criteria
Ability to aggregate the overall scores against the Threshold Values and populate respective Skills Buckets for ready reference to the clients.
Ability to identify the Skills Gap and recommend for Skills Refresh Needs.
Ability to integrate with the Skills Tracker Module of ManavSoft for the Skills Fulfillment

### 2. On-going Skills Inventory and Competency Management

This module will allow the client HR to carry out the following:
During the time of Employment Competency Mapping of the skills
Defining the Current Roles Skills Requirements Mapping assessment methods
Future Roles Skills Requirements Mapping
Assessment for Future Roles Fitment
   3. Skills Gaps Analysis and On-going Skills Refresh module
System Led Skills Gap Analysis for various Job Roles
User led Skills Gap Analysis for specific Job Roles Assessments
Recommendation on Training Needs
e-learning Modules Creator
Pre-configured e-learning Modules for Technical, Functional and Soft Skills

### 4. ManavSoft HR Functions Management

ManavSoft's HR Function Management Module as shown in FIGS. 6 and 7 enables the Client HR organization to:
Define Role based Performance Measures
Define Balanced Score Cards for Employees
Monitor Performance against pre-set parameters
Assess performance and create Pay for Performance and Incentives Calculations based on their performance measures
Integration with Client's Existing HR Information System and HR Management System
Training Tracker Modules for Employees Skills Refresh
   5. Relationship Management (Job Seeker and Employee) as shown in FIG. 4
Existing Resume Migration Capabilities
Ability to Profile Job Seeker/Employees for various Experience and Expertise Summary
Profiling the Job Seeker/Employees for Multiple Job Roles
Searching the suitability of the Job Seeker/Employees for multiple Job Functions
Maintaining the freshness of the profile with on-going relationship through SMS and e-mail Alerts
Personalization of Profiles
Skills Inventory Management for Job Seeker and Employees
Fuzzy and Intelligent Search.
SLA Management with Job Seeker and Employees
   Relationship Management (Internal Customers and External Clients) as shown in FIG. 2

On-line Search for Profiles based on Filters for immediate look-up to internal customers/clients
Client SLA Definition and Management
SLA based Service Fulfillment Tracking
Dynamic Change Management
Skills Demand Forecasting and Skills Fulfillment Planning
Resources Inventory Management
Access to Skills Buckets which provides access to Operations Ready Deployable Resources

Manavsoft's Gyan Sristi Knowledge Management Module can be used in two applications as detailed in the previous slides.

The first module is for the Talent Acquisition Process, whereby the clients HR Can define for various Job Roles Specific Selection Methods that are required for various Job Roles of the Organization as well as the Panel-led selection criteria using the Gyan Sristi Knowledge Engine.

These administrations of selection methods can be carried out from a central location and instantaneously broad cast on-line to various channels.

Gyan Sristi is also being rolled out as an independent module to various Resource Pools such as Colleges, Job Oriented Training Institutes and Specific Training Institutes for assessing the skill requirements against various job roles.

Such assessed profiles are captured in the Skills Buckets for various Job Roles.

Also during the assessment of profiles, Gyan Sristi has a provision to identify the Trainable Skills Profile who could be trained and assessed for Job Roles and their respective Talent Acquisition.

The second major application of Gyan Sristi is for assessment of the New Joinees, Employees especially in the remote locations using the on-line assessment methods for specific skills requirements, identify the Skills Gap, identify the specific Skills Refresh Requirements, direct them to specific e-learning portals of Gyan Sristi (Pre-configured) or to the custom built e-learning portals within the client organization.

Using various modules of ManavSoft has developed built-in ready to roll Custom Solutions to address some of the immediate operational requirements of Client HR Organization.

Manavsoft currently have two solutions viz., e-campus solutions, Survey Solutions.

E-campus solution is a customized roll-out for specific needs of the organization being configured in the Gyan Sristi Knowledge Engine which gets rolled-out to specific Colleges and Educational Institutions.

Survey Solutions are custom made surveys that could be engineered using the Gyan Sristi Engine to roll-out client specific survey needs such as Employee Survey, Salary Survey and any other client survey as required.

Manavsoft Productivity Tools are independent set of applications which are rolled out to bring in the operational productivity improvement measures in the client organization.

The current tools sets of Manavsoft are Bulleting Boards, Payroll Calculator, Pro-metric Tests, Self Assessment Tests, and Skills Matrix Mapping.

Manavsoft also comes with a pre-loaded self healing performance tuning mechanisms which enables the client organization to monitor the application performance monitoring, resource usages, and Tuning methods for improved performance.

| | Competency Mapping/Skills Matrix | | | | | | | | | |
|---|---|---|---|---|---|---|---|---|---|---|
| | Competency Mapping of Employees: | | | | | | | | | |
| | Job Role: | | | | John Smith | | | | | |
| | Skills | | | | Architect | | | Improvement Areas | | |
| Required | Competency | Expected Competency Levels | | | Current Competency Levels | | | Recommended Competency | | |
| Skills | Expectations | Adequate | Expert | Mentor | Adequate | Expert | Mentor | Adequate | Expert | Mentor |
| Business | Must Have | X | | | X | | | | | |
| Analysis | Essential | | X | | | | | | X | |
| | Nice to Have | | | X | | | | | | X |
| Business | Must Have | | X | | X | | | | X | |
| Architecting | Essential | | X | | | | | | X | |
| Skills | Nice to Have | | | X | | | | | | X |

Manavsoft Services are of two fold:

Application Roll-out Services with the services catalogue as mentioned above.

We would also be providing consulting Services in the areas of HR Process re-engineering, HR Organizational Transformational and Change Management Services and Organizational re-alignment Services.

Manavsoft has been developed with state-of the art technology platform and delivered end-to-end as a web services. It has been built using the open architecture to ensure inter-operability with the client set-up and for an easy intergratability with the client's HR Information Systems and HR Management Systems.

Manavsoft will deliver its services in three different SLA commients each with a specific scope of deliverables as per the client's requirements.

### ManavSoft Platinum Level of Services

Customized Services Roll-out as per the Scope
Legacy/Existing System Integration Services as per Scope
Data Migration Service as per Scope
ManavSoft Parameterization and Customization Services as per Scope
24×7 SLA Support
Three years Warranty and Support

### ManavSoft Gold Level of Services

Customized Services Roll-out as per the Scope
Legacy/Existing System Integration Services limited to 100 Man-days
Data Migration Service Limited to 100 Man-days
ManavSoft Parameterization And Customization Services Limited to 100 Man-days
12×6 SLA Support
Two years Warranty and Support

### ManavSoft Silver Level of Services

Customized Services Roll-out as per the Scope
Legacy/Existing System Integration Services limited to 50 Man-days
Data Migration Service Limited to 50 Man-days
ManavSoft Parameterization and Customization Services Limited to 50 Man-days
8×5 SLA Support
One year Warranty and Support

Manavsoft brings an Operational Efficiency and Effectiveness through reduction of Turnaround time, Cost and overall Life Cycle. Overall improvement in the Service Levels, HR Services Life Cycle, HR Budget and Organizational Productivity.

### Reduction in

Overall Recruient Cycle Time (Test case of 67% reduction).
Reduced Sourcing Cost due to on-going Job Seeker Relationship Management.
Overall Reduction in the Service Delivery or a Project Cost due to the availability of Right Resource at the Right Time.

### Improvement in

Increased Service Level Agreements with internal and External Clients
Overall Efficiency of the Recruient Life Cycle
Overall Quality of the Resources Attracted
Overall HR Budget
Overall Improvement in the Organizational Productivity
Overall Increase in the Opportunity Cost
Overall Open Interface of the HR Functions

Manavsoft follows a structured methodology for its client engagement and defined roll-out methodology for its delivery.

Initiation Phase

This phase addresses interactions, and discussions with the clients HR, Business Users, IT Users to understand their wants and needs.

Solution Design Phase

Designing a comprehensive HR solution to suit client's wants and needs. To Scope the Application Modules, HR Process Detailing, and extent of Strategic Consulting Services Required. Agree on the required Service Level Agreement (Silver, Gold or Platinum) and submit ManavSoft Roll-out Proposal.

Contracts Negotiation Phase

Subsequent to proposal submission, we enter into a formal agreement with our Clients to provide our services. The agreement will provision for the Service Level Agreements for Response Times, Turn-around Time, Services Description & Deliverables, Contractual Obligations, Commercial Terms and Conditions.

Services Initiation and Delivery Phase

ManavSoft will deploy experienced resources for Application Roll-out and very senior HR Resources with over decades of experience for the Strategic Consulting Services. ManavSoft will submit a detailed Delivery Project Plan as part of each proposal, which will detail the structured roll-out of its services.

Customer Relationship and On-Going Continuous Improvement Phase

An on-going exercise to enhance the client satisfaction and enable an efficient two way communication between the organizations for continuous improvement of our Services.

ManavSoft will be very keen to deploy its Consulting Resources to engage with the prospects to identify and Define the HR needs of the client organization.

### A Demo of How the Process Works

FIGS. 13-19 or Appendices 1-7 explains the web enabled method for skill alignment of human capital with dynamic requirements of prospective organization by identifying appropriate human capital on the basis of predetermined parameters; assessing existing skills of the identified human capital; identifying skill-gap of assessed human capital with respect to skill requirements of the organization; conducting specific training program to bridge the skill-gap of the human capital; and dynamically updating the profiles of successful trained human capital to align it with the requirements of the organization and a method for assessing performance of human capital and optionally aligning their skills with the requirements of the organization.

1. A web enabled method for managing a life cycle of human capital—related dynamic requirements of an organization, said method comprising steps of;
i. capturing existing goals and/or ethos and/or values of the organization across various business processes and thereby defining required competencies within and across various job families;
ii. setting role based performance measures and career growth plans based on defined competencies and captured goals;
iii. assessing the human capital on the basis of defined measures and plans to identify skill-gap of the human capital;
iv. conducting specific training program to bridge the skill-gap of the human capital and thereby obtaining balance score cards to profile the human capital competency;
V. integrating the assessed competency profile of the human capital in various organizational sourcing channels to enable the organization to search for internal and external sources; and
vi. maintaining the balance score cards of the assessed profile for fulfilling human capital service metrics and optionally, aligning skills of the assessed human capital with the dynamic requirements of the organization.

2. The method as claimed in claim 1, wherein the method provides Strategic Consulting Services selected from a group comprising Strategic Alignment, Organizational Change Management, Organizational (Re)-Design, Performance Benchmarks and Balanced Score Cards roll-out.

3. The method as claimed in claim 1, wherein assessing the performance using Productivity Tools selected from a group comprising of Bulletin Boards, Focused Communication Group, Pay for Performance Methods, Pro-metric Tests, Self Assessment Tests and Skills Matrix Mapping.

4. The method as claimed in claim 3, wherein the productivity tools are independent set of applications which are rolled out to bring in operational productivity improvement measures in the organization.

5. The method as claimed in claim 1, wherein the method comes with a pre-loaded self healing performance tuning mechanisms to enable the organization to align the application performance monitoring, resource usages, and tuning methods for improved performance.

6. The method as claimed in claim 1, wherein the method is built on open architecture to ensure inter-operability with the organization set-up and for an easy intergratability with the client's human resource Information Systems and human resource Management Systems.

7. The method as claimed in claim 1, wherein the method provides online portal for effective communication management within and across the various organizational entities.

8. The method as claimed in claim 1, wherein the method helps in identifying leadership attributes across the and within the organization.

9. The method as claimed in claim 1, wherein the method manages employee performance in an organization right through their career growth or to the end of the employment life cycle.

10. The method as claimed in claim 1, wherein the method provides succession planning and developing leadership of employee in the organization.

11. The method as claimed in claim 1, wherein the method helps in developing and maintaining partnership relations with various organizations.

12. The method as claimed in claim 1, wherein the method provides platinum premium services comprising Legacy/Existing System Integration Services, Data Migration Services, and Parameterization, Customization Services as per Scope and 24×7 Service Level Agreement Support.

13. The method as claimed in claim 1, wherein the method provides gold premium services comprising Legacy/Existing System Integration Services, Data Migration Service, and Parameterization, Customization Services as per Scope and 12×6 Service Level Agreement Support.

14. The method as claimed in claim 1, wherein the method provides silver premium services comprising Legacy/Existing System Integration Services, Data Migration Service, and Parameterization, Customization Services as per Scope and 8×5 Service Level Agreement Support.

15. The method as claimed in claim 1, wherein the external resource is selected from a group comprising business partner, Job fairs, employee referrals and sourcing partners.

16. A web enabled method for skill alignment of human capital with dynamic requirements of prospective organization, said method comprising steps of;
i. planning for organizational level manpower with HR budgets and thereby identifying appropriate candidates on the basis of pre-determined plans;
ii. assessing existing skills of the identified human capital using pre-determined quality control parameters;
iii. identifying skill-gap of assessed human capital with respect to skill requirements of the organization;
iv. conducting specific training program to bridge the skill-gap of the human capital; and
v. dynamically updating the score cards of trained human capital for various sourcing metrics to align it with the requirements of the organization.

17. The method as claimed in claim 16, wherein identifying the human capital on the basis of parameters selected from a group comprising Organizational Entity Human Resource Planning, Division Level Human Resource Planning, Skills Demand Forecast, Statistical Models Based Demand Prioritization Methods, Skill Requirements wise calendaring and Event Planner, Quality Parameters Setting for Each Skills Requirement, and Dynamic on-line allocation for Sourcing Channels.

18. The method as claimed in claim 16, wherein said assessment is either online assessment or consult-led assessment.

19. The method as claimed in claim 18, wherein the candidates undergo assessments tests selected from a group comprising Group Discussion, Interview and Reading tests for identifying their communication skills and personality standards.

20. The method as claimed in claim 16, wherein the method provides for On-line Tracking of Sourcing Channels, Dynamic Priority Change Management, Dynamic Allocation, De-Allocation and Re-allocation based on the business priorities, End-to-end Recruitment Life Cycle Monitoring, on-line Status Update for Internal Clients, Candidates Skills Induction Management including the Training Needs definition and Tracking, Employee Skills Competency Mapping, Tracking of HR Budgets and Facilitate the Employment Formalities.

21. The method as claimed in claim 16, wherein the method provides for relationship management between the organization and the candidate.

22. The method as claimed in claim 21, wherein the relationship management provides functions selected from a group comprising Existing Resume Migration Capabilities, Ability to Profile Candidate and/or Employees for various Experience and Expertise Summary, Profiling the Candidate and/or Employees for Multiple Job Roles, Searching the suitability of the Candidate and/or Employees for multiple Job Functions, Maintaining the freshness of the profile with on-going relationship through SMS and e-mail Alerts, Personalization of Profiles, Skills Inventory Management for Candidate and Employees, Fuzzy and Intelligent Search and SLA Management with Candidate and Employees.

23. The method as claimed in claim 17 wherein one or more functions and/or parameters are rolled out independently depending on the level of coverage, existing practice integration and/or alignment, and level of customization required and organizational environment for adoption of work flow driven approach.

24. A web enabled system for managing a life cycle of human capital—related dynamic requirements of an organization and for skill alignment of human capital, said system comprises;
a. a server controlled by a work-group computer;
b. said server connects candidate computer system and service provides computer system through communication network;
c. organizational Computer System connected to organization server to access service provider server which is connected to service provider system to provide requirements and to access candidate profiles through said communication network; and
d. means for storing pre-set skill parameters and profiles.

25. The system as claimed claim 24, wherein means for storing pre-set skill parameters and profiles are service provider database.

26. The system as claimed in claim 24, wherein the system provides online portal for communication management within and/or across the various organization.

27. The system as claimed in claim 24, wherein the database is skill bucket and profiles database resident in sever computer system connected to centralized web server through communication link.
